(19) United States
(12) Patent Application Publication
(10) Pub. No.: US 2007/0082121 A1
(43) Pub. Date: Apr. 12, 2007

(54) Processes For Texturing The Surface of A Hearing Instrument

(76) Inventors: Martin W. Masters, Hillsborough, NJ (US); Matthew Pietrafitta, Belle Meade, NJ (US); Therese Velde, Bridgewater, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/608,862

(22) Filed: Dec. 11, 2006

Related U.S. Application Data
(63) Continuation of application No. 09/944,315, filed on Aug. 31, 2001, now abandoned.
(63) Continuation of application No. 09/944,314, filed on Aug. 31, 2001.

(51) Int. Cl. B05D 3/00

(52) U.S. Cl. 427/2.24

(57) ABSTRACT

The physical fit, comfort, and appearance of a hearing instrument that resides in the ear can be improved by providing the shell of the instrument with a textured finish. A variety of textured finishes can be imparted during the fabrication process or applied after fabrication.

### CROSS-REFERENCE TO RELATED APPLICATIONS

This application is a continuation of application Ser. No. 09/944,314, filed Aug. 31, 2001, and related to application Ser. No. 09/944,315, filed Aug. 31, 2001, both incorporated by reference herein.

### BACKGROUND OF THE INVENTION

Typically, hearing devices inserted in a user's ear have a smooth or glossy finish, and the manufacturing process often includes a polishing phase to insure such a finish. Although this may provide an aesthetically pleasing appearance, the unit may have a tendency to slip out unless it has been sized to create an interference fit, in turn possibly leading to discomfort. Also, its shiny surface will make the presence of the unit in one's ear obvious to others as light reflects off the exposed surface.

### BRIEF DESCRIPTION OF THE DRAWINGS

FIG. 1 is an elevation view of a hearing instrument shell with a faceplate;

FIG. 2 is a cross-sectional drawing of a section of the surface of a sintered object textured by abrasive blasting;

FIGS. 3 and 4 illustrate surface textures comprising patterns of lines;

FIGS. 5 and 6 illustrate surface textures comprising patterns of ovals and circles, respectively;

FIG. 7 illustrates a portion of a layer of a hearing instrument shell having a non-textured surface;

FIG. 8 illustrates the shell portion of FIG. 7 with a rippled surface pattern; and

FIGS. 9-11 illustrate other surface texture patterns.

### DESCRIPTION OF THE INVENTION

By creating a textured, non-smooth finish on the outer shell of a hearing instrument, the hearing instrument will more readily lodge and remain within the ear canal. Further, the textured finish has an appearance closer to that of natural skin and therefore the hearing instrument is less noticeable to others, blending in with the visible portions of the ear.

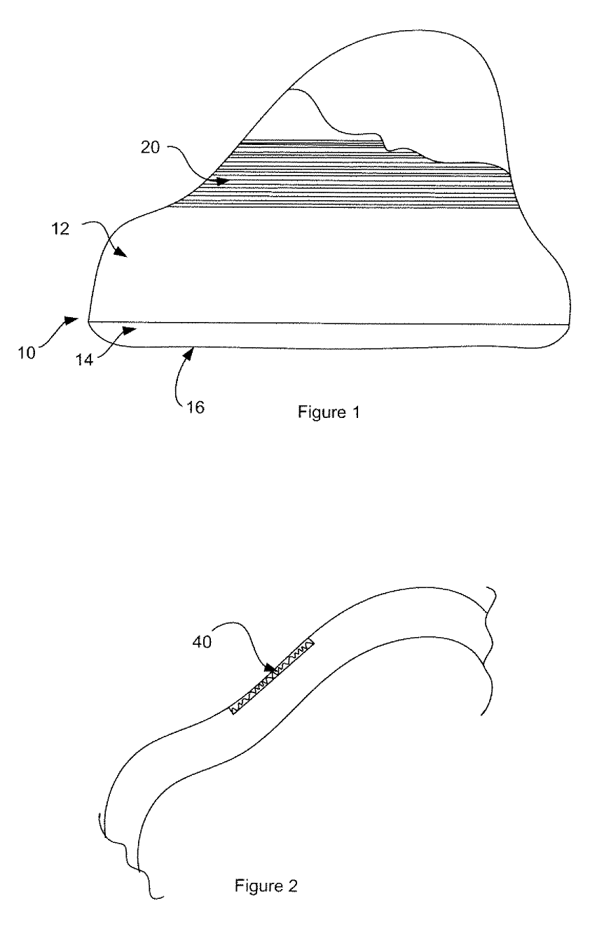

How a texture is imparted to the surface of a hearing instrument is dependent in part on the method used to fabricate the shell. Two methods of creating a shell are selective laser sintering and stereo lithography. In both of these cases, the shell is fabricated as a series of thin layers. A hearing instrument shell 10 is shown in FIG. 1, with a portion 20 of the outer surface 12 indicating the layered effect. This layered scheme of fabrication permits one to incorporate textures during the manufacturing phase.

Selective Laser Sintering

Equipment and materials suitable for selective laser sintering (“SLS”) may be obtained from DTM, Austin, Tex. The raw material for SLS is a powder, and in the case of a hearing aid instrument, powdered polyamide is suitable. Texturing can be achieved during the fabrication process, by imparting a pattern to the surface or layers that make up the object, as will be discussed below, or by applying a process after fabrication of the shell has been completed.

After fabrication, the surface of a sintered material can be textured by abrasive blasting. When created, a sintered product comprises a porous agglomeration of the powder. The individual particles are held together by bonds formed when adjacent particles are fused or “sintered.” By blasting the surface of the sintered product with abrasive media such as glass beads or grit for the amount of time necessary to achieve the desired effect, the outer particles will melt and fuse together. This results in a non-porous surface layer 40 approximately a few thousandths of an inch, as illustrated in the partial cross-section of FIG. 2.

The resultant texture of the surface will depend in part on the length of time of the blasting and the size of the abrasive or grit. Glass beads sized at 100-170 mesh applied at a pressure of 40-60 psi to a shell for 1-5 minutes have produced satisfactory results.

Instead of using an abrasive or grit blast, the surface of the shell may be fused and textured by applying ultraviolet light, laser, or focused sources of infrared heat, hot air, heat lamps, or any other source that will melt the surface particles. For example, an ultraviolet light source of 4000 watts per square centimeter applied for a period of 5 to 10 seconds will fuse the shell surface, as will a laser output of 10-15 watts. Focused infrared heat, hot air, or heat lamp output at 1000° F. for a period of 5 to 10 seconds can also be employed to texture a shell surface.

Stereo Lithography

As noted, a shell can also be fashioned using stereo lithography apparatus. Suitable apparatus for this purpose may be obtained from 3D Systems, Valencia, Calif. Here, successive layers of liquid resin are cured by precisely aimed beams of an ultraviolet light laser, resulting in a solid object comprising a series of layers, as shown in FIG. 1.

During fabrication, the laser can be programmed to create any desired pattern, as in the case of the sintered shell. Similarly, post-fabrication heat or abrasive treatment can be applied to create the desired surface texture.

Shell Textures

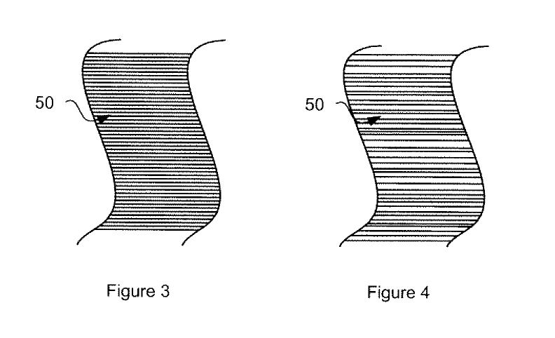

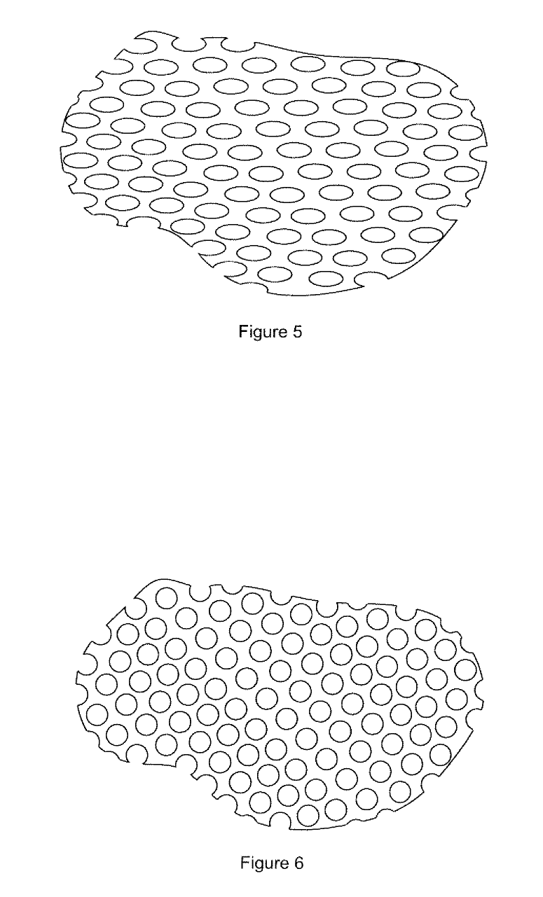

A variety of textures may be utilized with hearing instrument shells. The texture may be a series of lines 50, equally or unequally spaced (FIGS. 3 and 4), or a plurality of shapes (e.g., ovals and circles in FIGS. 5 and 6, respectively), or some other pattern, predetermined or randomly generated.

As noted in connection with selective laser sintering and stereo lithography, a texture can be imparted to the surface of the object by manipulating the laser (or another suitable tool) during the fabrication process. For example, by applying various waveforms to the edges of each layer, the layers collectively will present a textured appearance. This can be achieved by driving the laser with a waveform that results in a physical replica of that waveform at the edge of a layer. The laser beam can be moved in a specific or random meandering pattern, or its power can be varied over time, or the width of the laser beam can be varied, or a combination of the foregoing can be applied.

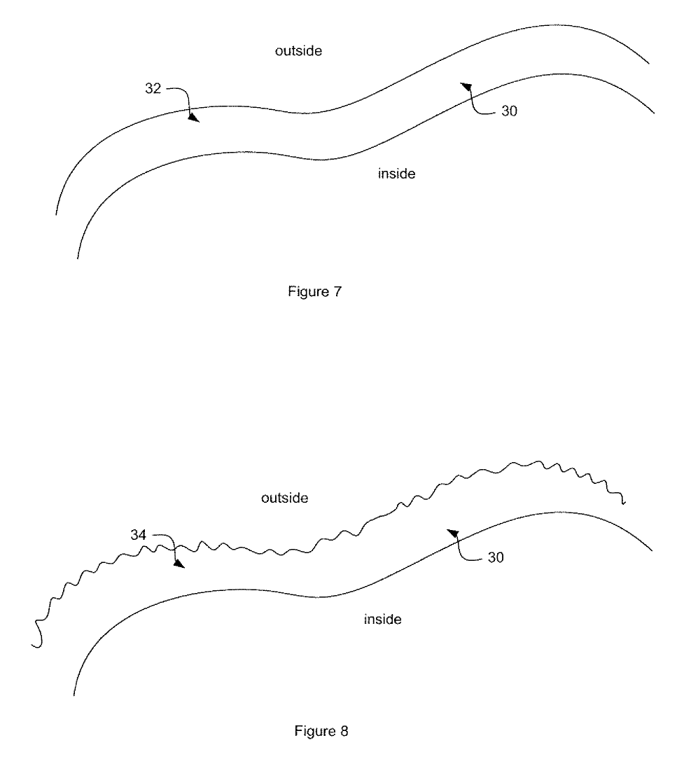

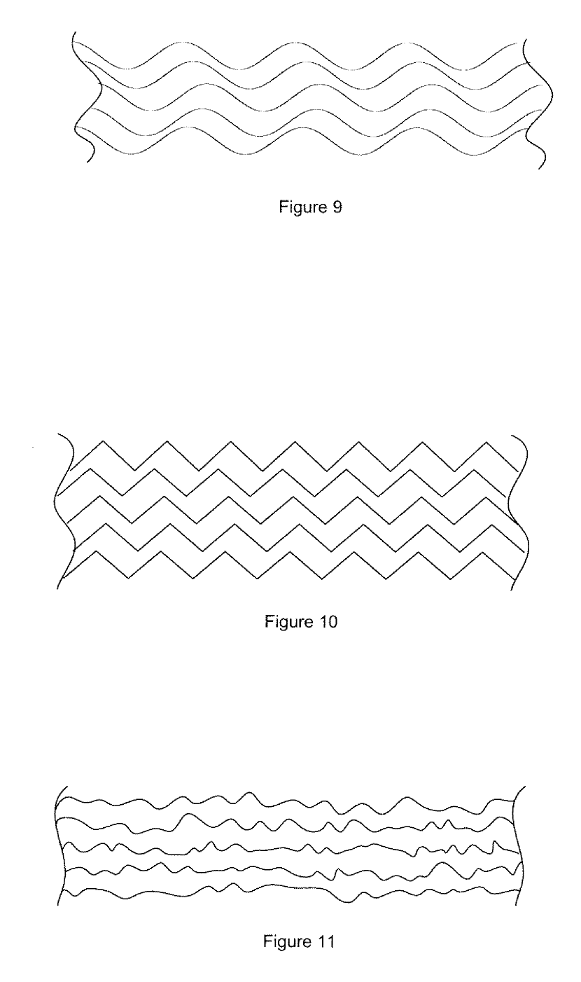

As an example, a portion 30 of a layer of an otherwise smooth shell might have the outer surface contour 32 of FIG. 7. The same shell portion 30 is again shown in FIG. 8, this time with a rippled outer surface 34. Moreover, the waveforms of successive layers can be offset to further vary the resulting texture. Depending on the operation of the laser, the texture may have a sinusoidal, sawtooth, random, or some other regular or irregular pattern (FIGS. 9-11). A finer pattern, such as a matte finish, could also be applied if desired.

In fabrication, during the creation of each successive layer, a laser is repeatedly pulsed and incrementally repositioned to delineate the contour of the layer. The distance between adjacent pulses can be varied from full overlapping to widely spaced, e.g., one to three beam diameters. This wide spacing can be used to break up the regular contours (i.e., the layers) that would otherwise result from the process of fabrication and contribute to a more desirable surface texture.

Texture Characteristics

The actual characteristics of the texture employed may be quite varied and are a matter of design choice and suitability to the application. The particulars of surface texture are well established and discussed at length in “Surface-Texture Designation, Production, and Control,” Marks' Standard Handbook for Mechanical Engineers, 9th ed., 1987, pages 13-75 through 13-81.

Other Fabrication Methods

While texturing has been discussed utilizing hearing instrument shells fabricated either by selective laser sintering or stereo lithography, textures can be established or applied to shells fabricated through other methods. For example, some shells are manufactured with custom molds derived from the surface contours of the user's ear. The mold cavity can be modified to create a texture in the fabricated shell or the shell can be treated as described previously as suits the material of the shell.

Additionally, the texture applied to the shell can also be used with the faceplate 14 (FIG. 1), the cover closing the broad end of the hearing instrument shell 10. A texture can be applied to the outer surface 16 of the faceplate 14 using the same techniques.

What is claimed is:

1. A method of fabricating a hearing instrument for insertion into the ear of a user, comprising:
fabricating a shell, where fabricating a shell comprises
fabricating a monolithic, ear-canal portion that lodges within the ear canal of the user, where fabricating a monolithic, ear-canal portion comprises
imparting a non-smooth texture to and integrally within the surface of the monolithic, ear-canal portion, where the non-smooth texture comprises a nearly skin-like appearance.

2. A method as set forth in claim 1, where imparting a non-smooth texture further comprises imparting a non-reflective finish.

3. A method as set forth in claim 1, where imparting a non-smooth texture further comprises imparting a non-smooth texture comprising a series of lines, equally or unequally spaced.

4. A method as set forth in claim 1, where imparting a non-smooth texture further comprises imparting a non-smooth texture comprising a plurality of regular or irregular repeating shapes.

5. A method as set forth in claim 1, where imparting a non-smooth texture further comprises imparting a non-smooth texture comprising a predetermined or randomly generated pattern.

6. A method as set forth in claim 1, further comprising fabricating a faceplate, and where imparting a non-smooth texture further comprises imparting the non-smooth texture to and integrally within the surface of the faceplate.

7. A method as set forth in claim 1, where imparting a non-smooth texture further comprises blasting the surface with an abrasive or grit.

8. A method as set forth in claim 1, where imparting a non-smooth texture further comprises applying ultraviolet light, laser, infrared heat, hot air, or another heat source to the surface.

9. A method as set forth in claim 1, where fabricating a shell further comprises fabricating a series of layers; and
imparting a non-smooth texture further comprises applying waveforms to the edges of one or more of the layers during the process of fabrication.

10. A method as set forth in claim 1, where
fabricating a shell further comprises fabricating a mold cavity derived from surface contours of the user's ear; and
imparting a non-smooth texture further comprises modifying the mold cavity to create a texture in the outer surface.
